(19) United States
(12) Patent Application Publication
(10) Pub. No.: US 2005/0070410 A1
(43) Pub. Date: Mar. 31, 2005

(54) Presentation folder with attachable pockets and method of making same

(76) Inventor: Mark S. Cordes, Ringwood, NJ (US)

Correspondence Address: James W. Badie, Esq.,;Stoll, Miskin & Badie, The Empire State Building, Suite 4710, 350 Fifth Avenue, New York, NY, 10118, US

(21) Appl. No.: 10/803,226

(22) Filed: Mar. 18, 2004

Related U.S. Application Data
(60) Provisional application No. 60/506,416, filed on Sep. 29, 2003.

(51) Int. Cl. B31B 13/60

(52) U.S. Cl. 493/128

(57) ABSTRACT

A method of making a presentation folder with attached pockets comprising preforming the pockets from a cardboard or multiply sheet and attaching the preformed pockets to a scored generally rectangular folder sheet of cardboard or multiply sheet wherein the scored fold divides the sheet folder in two halves. Each preformed pocket is attached to each of said folder sheet halves in alignment with the bottom and side of the sheet. A kit is also provided which comprises the scored sheet folder and the preformed pockets for attachment to the sheet folder.

### RELATED APPLICATION

This application relates to and claims the benefit of the filing date of provisional application Ser. No. 60/506,416 filed Sep. 29, 2003 entitled “Do It Yourself Presentation Folders With Attachable Pockets”.

### FIELD OF THE INVENTION

The present invention relates generally to folders, and in particular to a presentation or pocket folder having attachable pockets for insertion of loose papers, fliers and brochures for use in various business establishments. The invention also provides a method of making such presentation folder which is so simple to assemble that it can be referred to as “Do It Yourself Presentation Folder With Attached Pockets” and can be provided as a kit comprising the components used to make such folder.

### BACKGROUND OF THE INVENTION

File folders are staple articles usually found in stationery stores for use in offices and various business establishments. It is well known to provide folders with or without pockets, and several methods have been described in the prior art for making pocket folders. However, the known methods of making pocket folders are cumbersome and expensive particularly since they are made and used in large quantities. Several prior art type folders and their deficiencies are described in various patents. For example, U.S. Pat. No. 5,141,485 issued Aug. 25, 1992 to Ralph E. Welt describes a prior art folder with pockets referring to FIG. 1 thereof, made from a standard size piece of cardboard. As mentioned in said patent, the method described for making the folders are expensive and does not meet customers' demands. Various other patents are mentioned in the Welt patent, all of which describe different pocket folders and methods of their manufacture, but concludes that none of said patents disclose folders having separate file folder pockets which can be pre-formed conveniently and inexpensively and thereafter attached to a folder.

In order to overcome the expensive and cumbersome prior art methods of manufacturing folders with attached pockets, the Welt patent discloses an “inexpensive” method that involves making a pocket for application to a folder, and comprises die-cutting a sheet to form a plurality of sheets in a single die-cutting operation, forming in the sheet fold lines defining a pocket panel, a bottom tab for attachment along a bottom edge of the folder panel, and a side tab for attachment along a side edge of the folder panel; and applying to each of said tabs double coated pressure sensitive adhesive tape having a protective coating on one side thereof which is peelable therefrom for adhesive attachment to the folder panel. In the method of the Welt patent, the large panel folder is formed by single die-cutting a large folder sheet using the so-called “guillotine-cutting” process and thereafter folding the sheet along a fold line to form two generally rectangular folder panels each having a side edge parallel to the fold line, a top edge and a bottom edge. The pockets are then applied to the folder panel sheet as hereinbefore described.

While the Welt method is somewhat of an improvement over the prior art, it nevertheless does not offer the simplicity and inexpensive method described in this invention.

It is therefore an object of the present invention to provide a simple and inexpensive method of making pocket folders, also called presentation folders which are more convenient to make or assemble by the consumer.

It is a further object of this invention to provide a method of making the presentation folder from previously formed pockets and folder sheet and attaching the pockets to the folder sheet.

It is also an object of this invention to provide a kit comprising a folder sheet and pocket sheets with instructions for the consumer to follow in making the presentation folder by attaching the pockets to the folder sheet.

It is an additional object of this invention to provide a kit comprising the different components used to make presentation folder with attached pockets.

The foregoing and other objects and features of the present invention will now be described in the ensuing detailed description of the invention taken in conjunction with the accompanying drawings which form part of this application.

### SUMMARY OF THE INVENTION

The present invention provides a simple and inexpensive method of making presentation folders with attached pockets. The method comprises using a generally rectangular sheet folder with scored fold which divides the sheet folder into two equal halves to which preformed pockets can be attached. A generally rectangular pocket sheet is scored to form two panels, each panel having an upper side, a shorter bottom side and two side edges. The shorter bottom side edge has a glue flap with a lower side which us foldable over its upper side, and a pair of double-sided adhesive strips are provided on the glue flap. In order to attach the pocket to one side (half) of the sheet folder, the double-sided adhesive tape is removed and the pocket panel is attached to the sheet folder (half) and aligned therewith on its side and bottom. One such preformed pocket can be formed on each sheet folder to make a presentation folder having two attached pockets.

The present invention also provides a kit having one or more preformed pockets and sheet folders which can be used to form the presentation folder.

### BRIEF DESCRIPTION OF THE DRAWINGS

In the drawings like reference numerals are employed to designate like parts:

FIG. 1 is a plan view of a sheet used for forming the file folder;

FIG. 2 is a plan view of a pocket sheet having a glue flap for forming a left-hand pocket;

FIG. 3 is a plan view of the rear side of the left-hand pocket with double-sided peelable adhesive lines;

FIG. 4 is a plan view of a pocket sheet having a glue flap for forming the right hand pocket;

FIG. 5 is a plan view of the rear side of the right hand pocket with double sided peelable adhesive liner; and

FIG. 6 is a plan view of the presentation folder of the present invention with the left pocket and the right pocket attached to the folder.

### DETAILED DESCRIPTION OF THE DRAWINGS

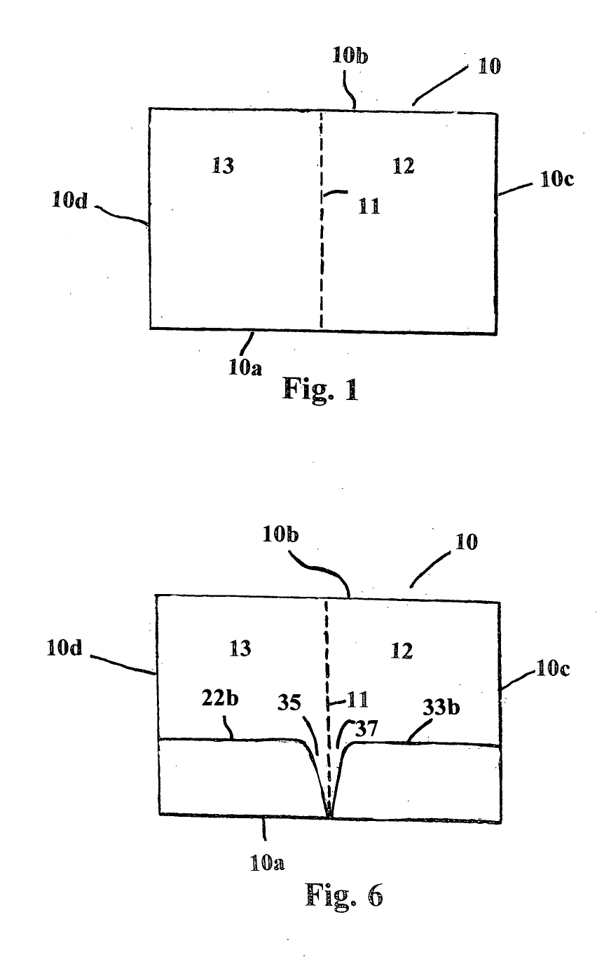

Referring first to FIG. 1, there is shown at 10 a generally rectangular sheet made of cardboard or multiply paper suitable for making a file folder. The sheet 10 has a scored fold (line) 11 along which the sheet 10 can be folded to form the half sheets or panels 12 and 13, each of which constitute half of the sheet 10. The sheet 10 is defined by the lower side edge 10a and the upper side edge 10b which are generally parallel to one another and the side edges 10c and 10d which are also generally parallel with each other.

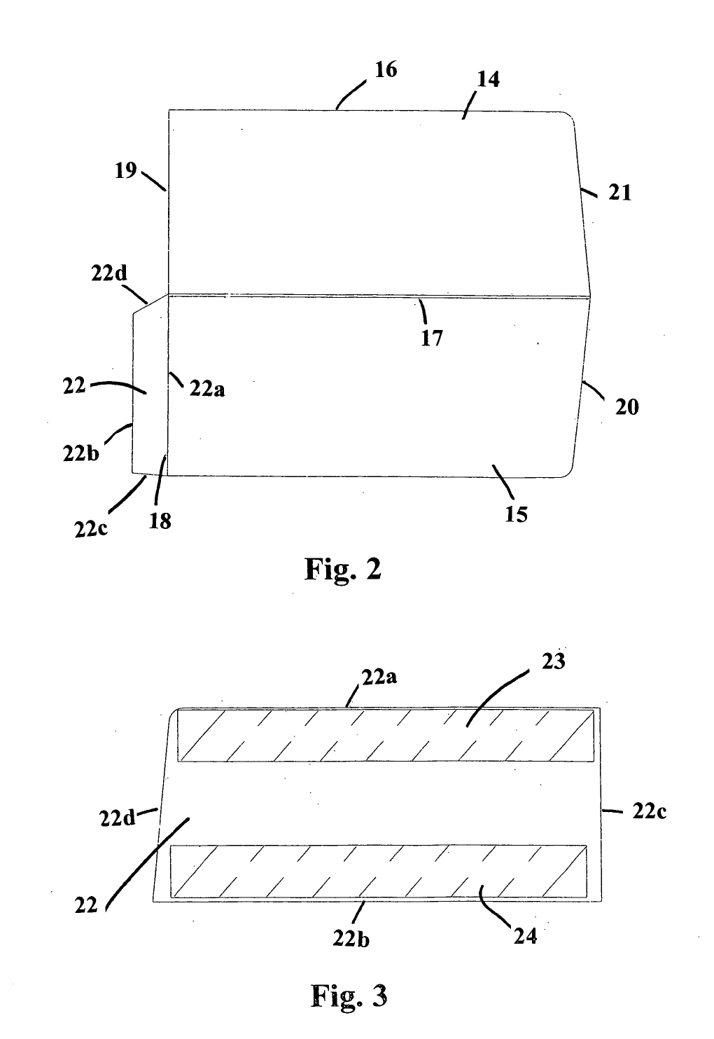

Referring to FIG. 2, there is shown a sheet 14 which as the sheet 10, is made of cardboard or multiply paper suitable for making a folder, defined by the longer side edges 15 and 16 and having a scored fold 17, and shorter side edges 18, 19, 20 and 21. As shown in FIG. 2, the side edges 18 and 19 are generally horizontal and the side edges 20 and 21 are tapered at both sides of the scored fold 17 toward the longitudinal sides 15 and 16. One of the short side edges, e.g., side edge 18 has a glue flap 22 which is defined by the longer top and bottom sides 22a and 22b, and the short side edges 22c and 22d, and which can be folded inwardly by folding the bottom side edge 22b over the side edge 18 of sheet 15. A suitable adhesive or glue is applied to the glue flap so that when the two pocket sheet halves are folded along the scored fold 17 a pocket is formed for attachment to the folder sheet as hereinafter described. As shown in FIG. 3, two strips of double-sided adhesive transfer tapes 23 and 24 are applied on the outer surface of glue flap 22. These strips are peelable and are disposed generally parallel and in close proximity to the side edges of the glue flap.

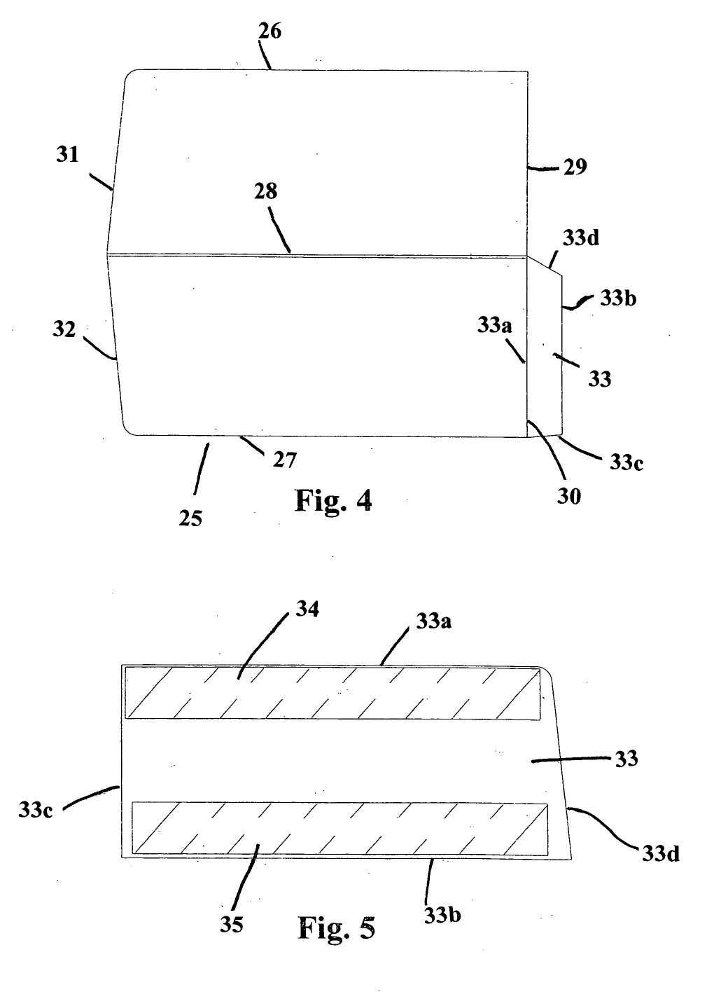

FIGS. 4 and 5 each is, respectively, mirror image of FIGS. 2 and 3 and depict similar structures for forming the right hand pocket. Thus, in FIG. 4, there is shown a sheet 25 which like sheets 10 and 14, is made of cardboard or multiply paper suitable for making a folder. The sheet 25 is defined by the longitudinal edges 26 and 27 and has a scored fold (line) 28, shorter generally horizontal side edges 29 and 30, and tapered side edges 31 and 32 which are tapered at both sides of the fold line 28 toward the longitudinal sides 26 and 27 as shown in FIG. 4. One of the short side edges, e.g., side edge 30 has a glue flap 33 which is defined by the longer top and bottom side edges 33a and 33b, and the shorter side edges 33c and 33d, and which can be folded inwardly by folding the bottom side edge 33b over the side edge 30 of sheet 26. A suitable adhesive or glue is applied to the glue flap so that when the two pocket halves are folded along the scored fold 28, a pocket is formed for attachment to the folder sheet. Referring to FIG. 5, there is shown the glue flap 33 having two strips of double-sided adhesive transfer tapes 34 and 35 applied to the outer surface of the flap. The strips 34 and 35 are peelable and are disposed generally parallel in close proximity to the sides of the glue flap.

The pockets formed as hereinbefore described are now ready to be applied to the folder sheet 10 to form the presentation folder, i.e., the pocket folder. Referring to FIG. 6, in order to attach each pocket to the correct half sheet, i.e., the right pocket to the right half sheet, and the left pocket to the left half sheet, starting with the left pocket, for example, the adhesive strips 23 and 24 are first peeled off by hand from the surface of the glue flap 22 and the pocket is then attached to the lower inside of left sheet 13 of the folder sheet 10 by aligning side edges 22a of the left pocket sheet with the lower side edge 10a of the half sheet 13 and applying slight pressure to attach the left pocket to the left sheet. The right hand pocket can thereafter be attached to the right half sheet 12 in the same manner as the left pocket. After both the left hand and the right hand pocket have been attached, the sheet folder 10 may be folded over the score fold 11 thus forming a two-sided pocket folder or presentation folder. As can be seen from FIG. 6, after each pocket is attached as aforesaid, there will be an opening such as opening 35 and 37 for receiving documents, etc.

The presentation folder hereinbefore described is shown as a rectangular folder with the pockets shown as identical in dimensions and configuration. This description, however is not intended to limit the configuration or dimensions of the folder. For example, the folder may be square-shaped and the pockets need not be identical in size but, as a practical matter, the configuration described herein is preferred. Thus, for the purpose of use in most offices and business establishments, the folder sheet itself may be 11 inches to 18 long and 8½ to 12 inches wide. Similarly, the pocket dimensions may vary and is usually from 5 to 8^{7/8} inches long and 3 to 4½ inches deep for receiving various sized documents. If it is intended to insert business cards or similar cards in the pockets, each pocket may be provided on its folded surface with one or more slits conveniently dimensioned for insertion of such cards.

The folder sheet and the pocket sheet are usually formed by known die-cutting methods using conventional die-cutting equipment, and these sheets are scored by conventional die-cutting methods known in the art as described, for example, in the aforementioned Welt patent.

In accordance with the present invention, consumers may be provided with a kit which contains, in non-assembled form, the components used for making the described presentation folders. It is thus contemplated that such a kit would comprise at least one, but preferably a plurality of separate folder sheets and pocket sheets accompanied by instructional documents for assembling the components which form the presentation folder.

It can be appreciated from the foregoing description and drawings that the present invention is not limited to the embodiment herein described and that different variations are possible. Such variations are nevertheless obvious and are suggested from the present description.

1. A method of making a presentation folder having attached pockets, which method comprises:
(a) forming a fold line in a generally rectangular sheet folder, said fold line dividing said sheet into a left folder panel, and a right folder panel, each of said panels having a longer side edge, a top side edge and a bottom side edge,
(b) forming a fold line in at least one generally rectangular pocket sheet, said fold line dividing said pocket sheet into two half panels, an upper panel and a lower panel, each of said panels having longer side edges, a short top edge and a short tapered bottom edge, said short bottom edge having a glue flap defined by a longer top side, a shorter bottom side and two side edges,
(c) folding said glue flap by folding said bottom edge over said top edge of said glue flap,
(d) providing two peelable double sided adhesive strips on said glue flap,
(e) removing said double-sided adhesive strips and attaching said pocket sheet to one half of said rectangular sheet.

2. A method as in claim 1 wherein two pockets are formed with each pocket being attached to one of said folder panels.

3. A method as in claim 1 wherein said sheet folder is generally square in configuration.

4. A method as in claim 2 wherein said sheet folder is generally square in configuration.

5. A kit for user in making a pocket folder which comprises at least one preformed pocket and at least one preformed scored sheet folder, both made according to the method of claim 1.

6. A kit for use in making pocket folders comprising a plurality of preformed pockets and a plurality of preformed scored sheet folders, both made according to the method of claim 1.
